(19) United States
(12) Patent Application Publication
(10) Pub. No.: US 2008/0179141 A1
(43) Pub. Date: Jul. 31, 2008

(54) GROUND CONVEYOR FOR RIDE-ALONG OPERATION

(75) Inventor: Michael Niebuhr, Bargteheide (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 12/016,514

(22) Filed: Jan. 18, 2008

(30) Foreign Application Priority Data
Jan. 30, 2007 (DE) 10 2007 004 481.1

(51) Int. Cl. B66F 9/06

(52) U.S. Cl. 187/222

(57) ABSTRACT

Ground conveyor for ride-along operation with a load-bearing means, which is adjustable in height by means of a lifting device on a frame and at least one steerable drive wheel driven by a drive motor, a platform for an operator and control elements for the drive motor, the steering of the drive wheel, the lifting device and suchlike, wherein the platform in the frame is swivel mounted on a vertical axis and can be positioned in a desired angle position with respect to the frame by rotating drive means or traction drive means, at least one drive wheel is mounted on the bottom side of the platform, the control elements are provided on an uptight part attached to the platform and the steering takes place with the help of the rotating drive means.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

One generally differentiates between two different types of ground conveyors: walk-along and ride-along ground conveyors. Walk-along ground conveyors are usually actuated by a drawbar, the head of which is provided with control elements for the vehicle, wherein the steering takes place via a drawbar pivoting movement. Ride-along vehicles with drawbar steering are also known. In this case, the operator stands on a platform or operates the vehicle functions while sitting. Drawbar-steered walk-along ground conveyors are typically more compact than ride-along vehicles.

The object of the invention is to create a ground conveyor for ride-along operation, the dimensions and working step widths of which are not or are only slightly higher than conventional ground conveyors with drawbar operation for walk-along mode. The intuitive operation and the functioning in both the drive and the load directions should be similarly good, as in the case of conventional drawbar devices for walk-along mode.

### BRIEF SUMMARY OF THE INVENTION

In the case of the ground conveyor according to the invention, the platform in the frame of the vehicle is swivel mounted on a vertical axis. The platform is rotated by suitable rotating drive or traction drive means into a desired angle position with respect to the frame. At least one drive wheel is mounted below the platform. The control elements are attached to an upright part connected to the platform. The steering takes place with the help of the rotating drive or traction drive means.

A rotatable platform, to which at least one drive wheel is attached and from which a suitable drive can be driven, is located in the part of the ground conveyor according to the invention turned away from the load bearing means. One part of the rotatable platform extends towards the top side of the ground conveyor and forms there an operator's stand for the operation of the ground conveyor. The operator's stand is compact and suitable for standing operation, wherein operation from a seated position is also conceivable, which would however require that the dimensions of the ground conveyor be designed accordingly larger.

In the case of the invention, the operator's stand is part of the rotation body, which is tightly connected to the fixed parts of the ground conveyor, which are located above the floor of the operator's stand. The operator can enter the operator's stand from the open side. Required components of the ground conveyor, such as e.g. electronic controls and batteries can be housed in the area inside the operator's stand, which is not taken up by the operator.

The uniqueness of the invention is that the ground conveyor is steered in that the operator's stand is turned around a high axis relative to the frame of the ground conveyor, which is stationary to the load bearing means. This rotation can take place at 360° or n times 360°.

In accordance with one embodiment of the invention, the upright part is shaped like a skirt that is curved to the outside and that is attached in the edge area of the circular platform. In accordance with a further embodiment of the invention, the skirt can be enlarged radially in the upper area. The skirt is generally designed so that is has a circular-arc-shaped cross-section.

In accordance with another embodiment of the invention, the circular platform is enclosed in a circular manner by a frame section. The circular platform preferably lies with its top side at the same height as the surrounding frame section.

If, according to one embodiment of the invention, a pair of coaxial drive wheels is arranged on the bottom side of the platform, the platform can be rotated in that the drive wheels are operated in the opposite direction by separate drives. A change in the drive direction can also be achieved in this maimer. In order to change the driving direction, the platform is rotated by 180° or, as is generally customary, a rotational direction change of the drive. Castor rollers can also be mounted on the platform or the frame section in circumferential distance to the drive wheels in order to better support the platform in accordance with another embodiment of the invention.

However, if, according to another embodiment of the invention, one single drive wheel is mounted close to the middle below the platform, a separate rotating drive is provided for the platform. The rotating drive can either be located on the platform or it can also be housed in the frame.

As already mentioned, the ground conveyor according to the invention is operated from the upright part of the operator's stand. For this reason, according to one embodiment of the invention, a grip for each hand can be attached to the upright part, to which the control elements for the drive motor, the rotating drive means or suchlike are attached. At the same time, the grips can also be grab handles for the operator.

In accordance with one embodiment of the invention, the grips can be designed as horns projecting towards the middle. In this connection, it can be provided that the grips are designed as bent end sections of a fixed rod that is bent towards the upright part. The control elements can be formed from rotatable grip sections of the grips, from thumb switches or similar control elements.

### BRIEF DESCRIPTION OF THE SEVERAL VIEWS OF THE DRAWINGS

The invention is explained in greater detail using drawings.

FIG. 1 shows a perspective view of a ground conveyor according to the invention while driving in the drive direction.

FIG. 2 shows a perspective view of the ground conveyor according to FIG. 2 from the load part without an operator.

FIG. 3 shows a front view of the ground conveyor according to FIG. 1.

FIG. 4 shows a perspective view of the front side of the ground conveyor according to FIG. 2.

FIG. 5 shows perspective views of the ground conveyor according to FIG. 1 through 4 in two opposite driving directions,

FIG. 6 shows perspective views of the frame and load part of the ground conveyor according to FIG. 1 through 5.

FIG. 7 shows a similar arrangement as FIG. 6 with additional steering rollers.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

The figures show a low-lift ground conveyor 10. It has a pair of wheel arms 14 as load-bearing means, each with a load wheel 16 on the front end. The wheel arms 14 are attached to a frame section 18. It can be extended by a certain distance by a lifting device (not shown), wherein the load wheels 16, which are mounted on rockers, are moved downwards with respect to the wheel arms 14, as is generally known in connection with low-lift ground conveyors. The details are thus not shown and are not described further.

Adjacent to the wheel arms 14, an upright part 20 is attached to the frame section 18. The frame section 18 surrounds a circular standing platform 22 with a circular section, the top side of which is almost at the same height as the flat top side of the frame section 18. The standing platform 22 is mounted at a vertical axis that can be rotated in the flame section 18. An operator 24 stands on it when operating the ground conveyor 10.

An upturned skirt 26 is arranged on the edge of the standing platform 22. It is shaped like a circular arc and extends radially in the upper area, as can be seen with 28. An operator control panel 30, which can contain control elements and display devices (not shown), is located on the inside of the extended section 28. Moreover, above the control panel 30 near the extension 28 of the skirt 26, a circular-arc-shaped bent rod 32 is arranged, which almost lies in a horizontal plane and has on the ends horns 34, 36 bent back to the insides, on the ends of which driving switches 38, 40 are swivel mounted in the form of rotating grips.

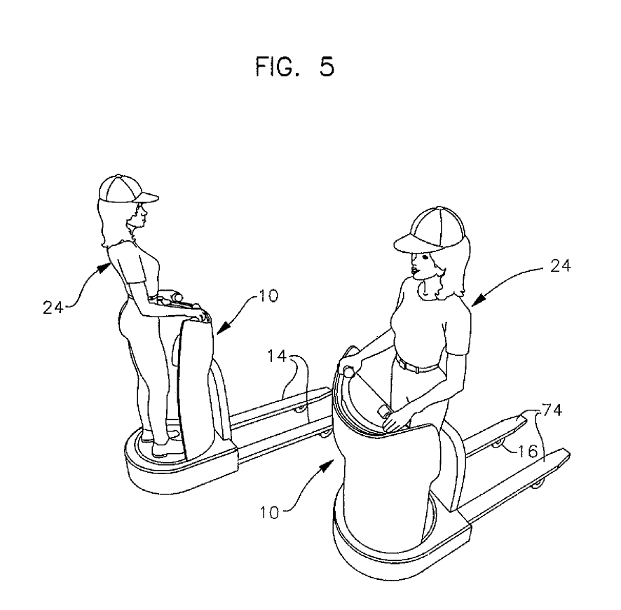

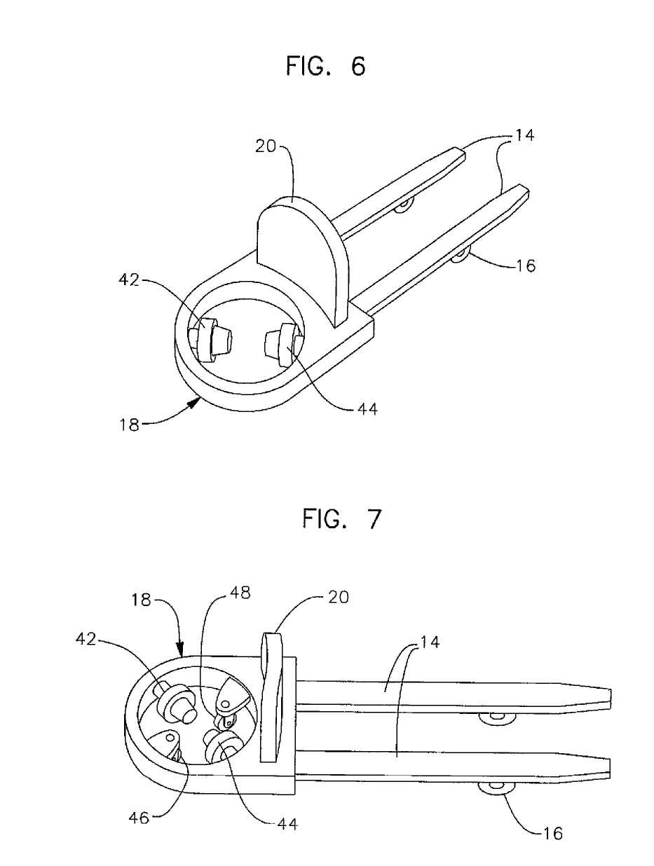

The standing platform 22 can be rotated by 360° or n times 360°. Thus, the operator can have different orientations with respect to the direction of the ground conveyor, as is shown in FIG. 5. The left image shows the line of sight to the wheel arms 14 and the right image the opposite direction. A rotation of the standing platform 22 is e.g. effected by two drive wheels 42, 44 (FIGS. 6 and 7) which are mounted on the bottom side of the standing platform 22 and are each driven by a drive. The drive wheels 42, 44 are located on the same axis and can be driven in both rotating directions. Different speeds or opposite rotational directions lead to a rotation of the standing platform 22. It is thus possible to steer the ground conveyor 10 via the rotation of the standing platform 22 while it is simultaneously being operated. It is naturally also conceivable to mount one single drive wheel on the bottom side of the standing platform 22 and to provide another rotating drive for the standing platform in order to steer it.

FIG. 7 shows how steering rollers 46, 48 are attached to the frame section in order to stabilize the vehicle. The steering rollers 46, 48 are each arranged offset from the drive wheels 42, 44 by 90°.

The drive motor is preferably located in or below the standing platform 22, while the battery is arranged on the inside of the skirt 26.

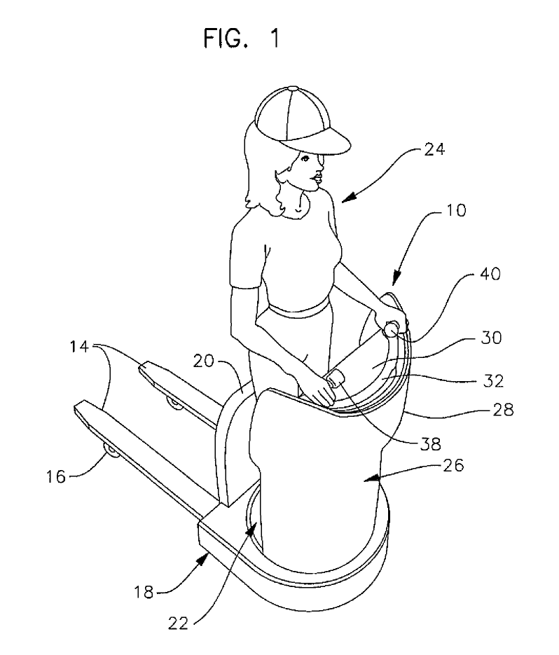

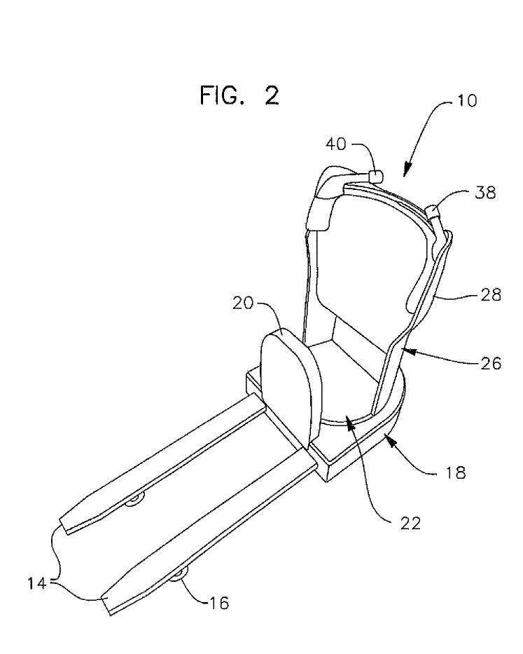

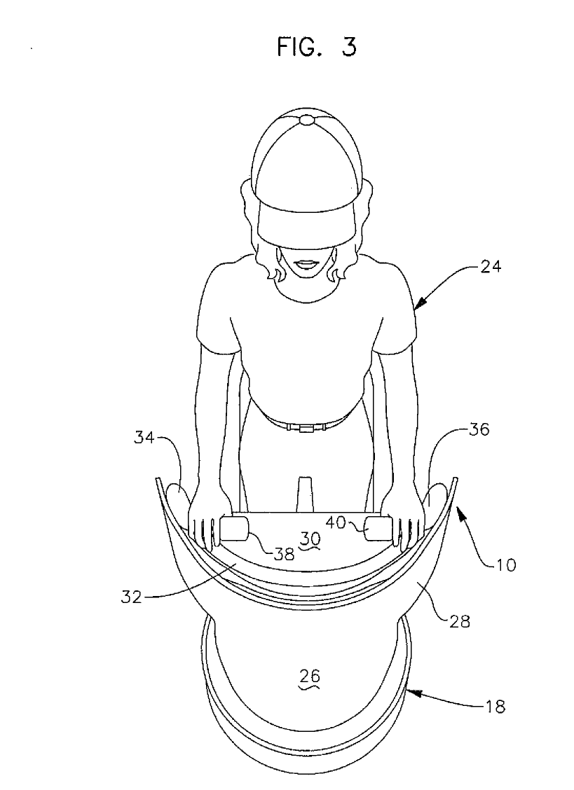

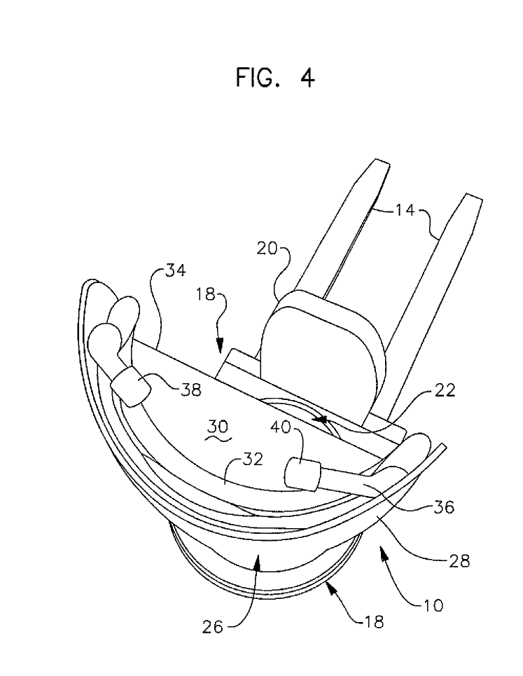

As can be seen in FIGS. 1, 3 and 5, the operator 24 can hold onto the horns 34, 36 in order to ensure a secure stance during the drive. The operator can also hold onto the rod 32 to secure him/herself.

As can be seen, a ground conveyor is shown in ride-along mode, the dimensions and working step widths of which are not or are only slightly higher than that of a conventional ground conveyor with drawbar operation for walk-along operation. The intuitive operation and the functioning in both the drive and the load directions should be similarly good, as in the case of a conventional drawbar device. The operator's stand is compact and designed for standing operation and mainly encloses the area taken up by the standing operator. The operator can enter the operator's stand from the open side. A steering function can be operated e.g. through the one-sided rotation of the rod 32 to the left or right by a certain amount. The deflection angle thereby determines the speed of the steering movement. The rotary motion of the standing platform 22 stops in the neutral position. The driving direction can be changed for example by rotating the steering by 180°.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What we claim is:

1. Ground conveyor for ride-along operation with a load-bearing means, which is adjustable in height by means of a lifting device on a frame and at least one steerable drive wheel driven by a drive motor, a platform for an operator and control elements for the drive motor, the steering of the drive wheel, the lifting device and suchlike, characterized in that the platform (22) in the frame (18) is swivel mounted on a vertical axis and can be positioned in a desired angle position with respect to the frame by rotating drive means or traction drive means, at least one drive wheel is mounted on the bottom side of the platform (22), the control elements are provided on an upright part (26) attached to the platform (22) and the steering takes place with the help of the rotating drive means.

2. Ground conveyor according to claim 1, characterized in that the platform (22) is swivel mounted at 360° or more.

3. Ground conveyor according to claim 1, characterized in that the upright part (26) is shaped like an outwardly curved skirt, which is attached in the edge area of the circular platform (22).

4. Ground conveyor according to claim 3, characterized in that the skirt (26) has a circular-arc-shaped cross-section.

5. Ground conveyor according to claim 4, characterized in that the skirt (26) has an upper radially extended area (28).

6. Ground conveyor according to claim 1, characterized in that the circular platform (22) is surrounded in a circular manner by a frame section.

7. Ground conveyor according to claim 1, characterized in that the circular platform (22) almost has the same height as the top side of the frame section (18) surrounding the platform (22).

8. Ground conveyor according to claim 1, characterized in that two coaxially arranged drive wheels (42, 44), which can be driven by separate drive motors, are mounted on the platform (22).

9. Ground conveyor according to claim 8, characterized in that castor rollers (46, 48) are mounted on the platform (22) or on the frame section (18) in the circumferential distance of the drive wheels (42, 44).

10. Ground conveyor according to claim 1, characterized in that one single drive wheel is mounted close to the middle below the platform (22) and a separate rotating drive is provided for the platform (22).

11. Ground conveyor according to claim 1, characterized in that one grip for each hand is attached to the upright part (26), on which control elements are arranged for the drive motor and the rotating drive means.

12. Ground conveyor according to claim 11, characterized in that the grips are designed as horns (36, 38) projecting towards the middle.

13. Ground conveyor according to claim 11, characterized in that the grips are designed as end sections of a rod (32) bent towards the upright part (26) and back towards the middle.

14. Ground conveyor according to claim 11 characterized in that the control elements are designed as thumb switches.
